(19) United States
(12) Patent Application Publication
(10) Pub. No.: US 2004/0221236 A1
(43) Pub. Date: Nov. 4, 2004

(54) Happy, interesting, quick learning inputting method of Chinese characters in stroke character pattern codes

(76) Inventor: Kam Chung Choi, Hong Kong (CN)

Correspondence Address: GREER, BURNS & CRAIN, 300 S WACKER DR, 25TH FLOOR, CHICAGO, IL, 60606, US

(21) Appl. No.: 09/957,290

(22) Filed: Sep. 20, 2001

(51) Int. Cl. G06F 17/00

(52) U.S. Cl. 715/535

(57) ABSTRACT

In the inputting method, the geometric figures of Chinese character strokes are divided into seven supergroups of character patterns, in which 100 code elements of character patterns are extacted, each code element is represented by an English alphabet and an Arabic numeral, and the serial nmbers are 0, 1, 2, 3, 4, 5, 6 respectively. Above code elements are allocated at the corresponding English alphabet key sites on an inputting keyboard, utilizing the keyboard, inputting of the Chinese characters can be performed in accordance with the quadrangle coding or the beginning and the end coding of Chinese chaactrs. The inputting method is convenient and flexible, and compactible with a plurality of inputting methods.

The invention relates to the technical field of Chinese character information processing, more specifically to the computer inputting method of Chinese characters.

In many years, the computer inputting method of Chinese cters was a bottleneck problem, although at present there were hundreds of computer inputting methods of Chinese characters, however, a wide gap lies between most exist inputting methods in prior art and an deal inputting method which is convenient in operation, easy in memory, and free from dialect articulation. Drawbacks of phonetic code, phonetic transcription andlor notation cods inputting methods of Chinese characters lie in: first, being limited by the sounding of dialect articulations, second, in the cases of different dialects, handling of phonetic transcription and/or notation is also uneasy. To be free from dialects, the inputting methods can only be stLdied based on characteristic pattern of Chinese characters, consequently, in comparison, pure shape codes being more applicable and spreadable In scientificalness and universality.

Chinese characters are pictographs, a character is formed by strokes, Yarious characters are featured in their sorting of character patterns and stroke orders. Accordingly, two main trends are also classified in the coding of character pattern inputting method, first is the coding in accordance with stroke order, like the inputting method of stroke order in China; second is the coding according to characteistios of font stn e.g. the [symbol] (CamgJi) inputting method in Taiwan and “WBZX” inputting method in China. To improve these two coding methods, then it shall be done to incorporate the phonetic transcription and/or notation, like the “Double Code” or “Yin and Yang” inputting method in China.

An object of the invention is providing a happy interesting quick leaning inputting method of Chinese characters in stroke character pattern code to overcome the drawbacks in the prior art.

According the invention, ffiere is provided a happy, interesting, quick leaing input method of Chinese characters in stroke character pattern code provided by the invention, in which:

a. 100 Chinese character input code elements are sorted according to seven supergroups of character patterns in [symbol] (dot), [symbol] (line), [symbol] (cross), [symbol] (corner), [symbol] (open), [symbol] (squares) and [symbol] (special) of Chinese characters, wherein each of the supergroups are further sorted into some subgroups and there are 30 subgroups in total as seen in the first columns of followihg tables 1-7. Characteristics name of each subgroup is shown with Chinese Spelling disposed below thereof and put into parentheses, to be understood with case. There will always be Chinese Spelling following each Chinese character and also put into parentheses in the description for the same reason .100 code elements are allocated on the key sites of English alphabet, and the auxiliary stroke character pattern code elements are discriminated by the corresponding digit serial numbers, a layout of the keyboard arrangement is as follows,

TABLE 1

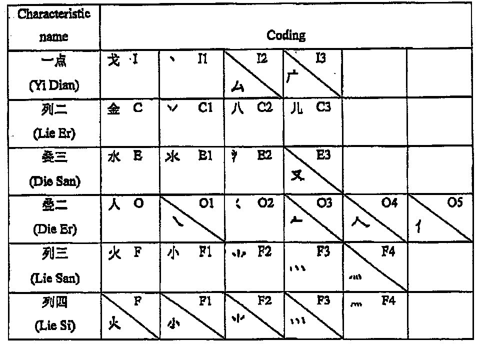

TABLE 2

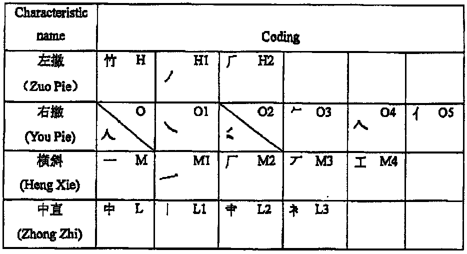

TABLE 3

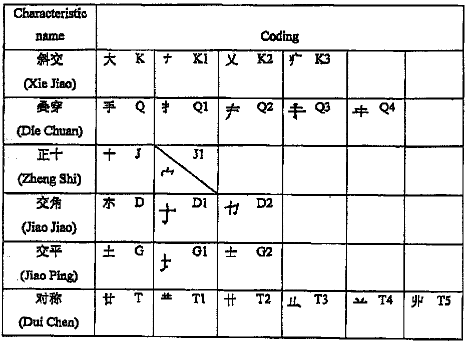

TABLE 4

| | |
|---|---|
| Characteristic | |
| name | Coding |

| | | | | | |
|---|---|---|---|---|---|
| [symbol] | [symbol] V | [symbol] V1 | [symbol] V2 | [symbol] V3 | |
| (Zuo Jiao) | | | | | |
| [symbol] | [symbol] N | [symbol] N1 | [symbol] N2 | [symbol] N3 | [symbol] N4 |
| (Yoy Jiao) | | | | | |

TABLE 5

| | |
|---|---|
| Characteristic | |
| name | Coding |

| | | | |
|---|---|---|---|
| [symbol] | [symbol] W | [symbol] W1 | [symbol] W2 |
| (Da Kou) | | | |
| [symbol] | [symbol] A | [symbol] A1 | [symbol] A2 |
| (Shuang Kou) | | | |
| [symbol] | [symbol] R | | |
| (Dan Kou) | | | |

TABLE 6

| | |
|---|---|
| Characteristic | |
| name | Coding |

| | | | | | |
|---|---|---|---|---|---|
| [symbol] | [symbol] B | [symbol] B1 | [symbol] B2 | [symbol] B3 | [symbol] B4 |
| (Xia Kai) | | | | | |
| [symbol] | [symbol] U | [symbol] U1 | [symbol] U2 | [symbol] U3 | |
| (Shang Kai) | | | | | |
| [symbol] | [symbol] S | [symbol] S1 | [symbol] S2 | [symbol] S3 | [symbol] S4 |
| (Ce Kai) | | | | | |

TABLE 7

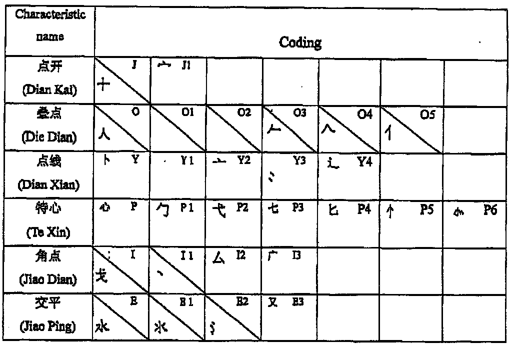

b. On inputting Chinese characters, the order is in accordance with the rules of Chinese character quadrangle or the beginning and the end of Chinese characters, and the above corresponding stroke character pattern code elements are keyed in by aforementioned keyboard.

Incorporating with e attached drawings, specific embodiments of the invention shall be described in detail. In which,

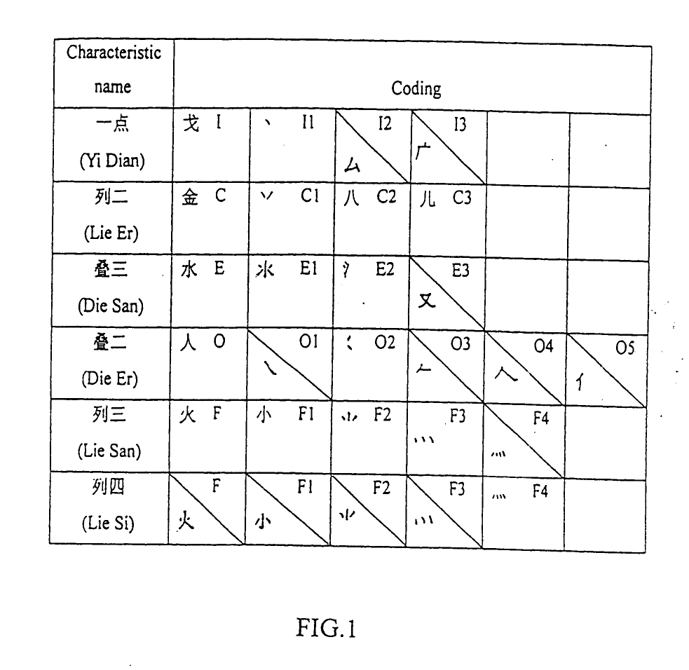

FIG. 1 shows the stroke code elements of “dot” character pattem, which are 16 in total;

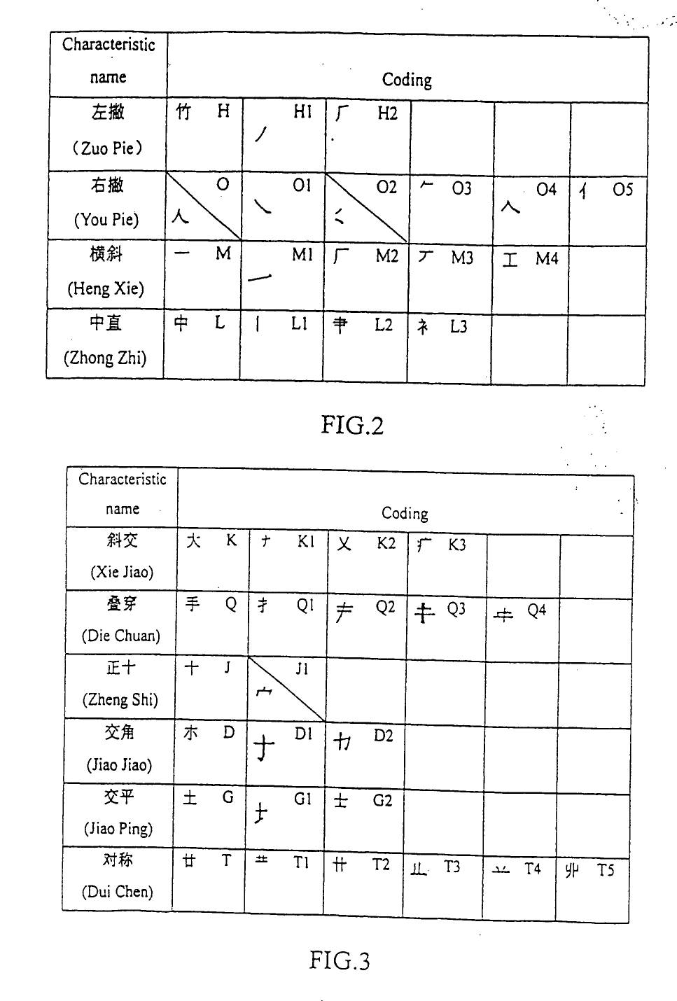

FIG. 2 shows the stroke code elements of “line” character pattern, which are 16 in total;

FIG. 3 shows the stroke code elements of “cross” character pattern, which are 22 in total;

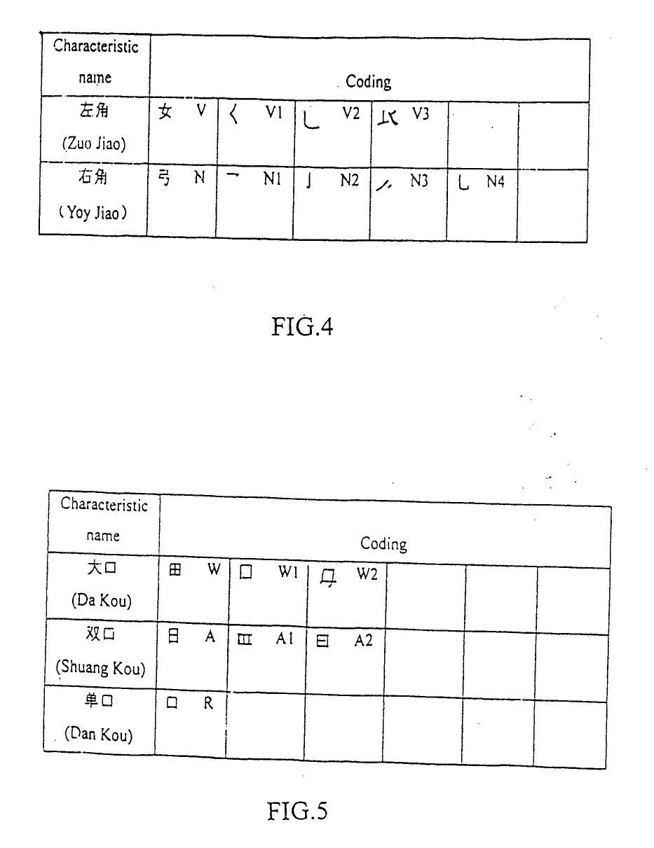

FIG. 4 shows the strode code elements of “corner” character pattern, which are nine in total;

FIG S shows the stroke code elements of “open” character pattern, which are 14 in total;

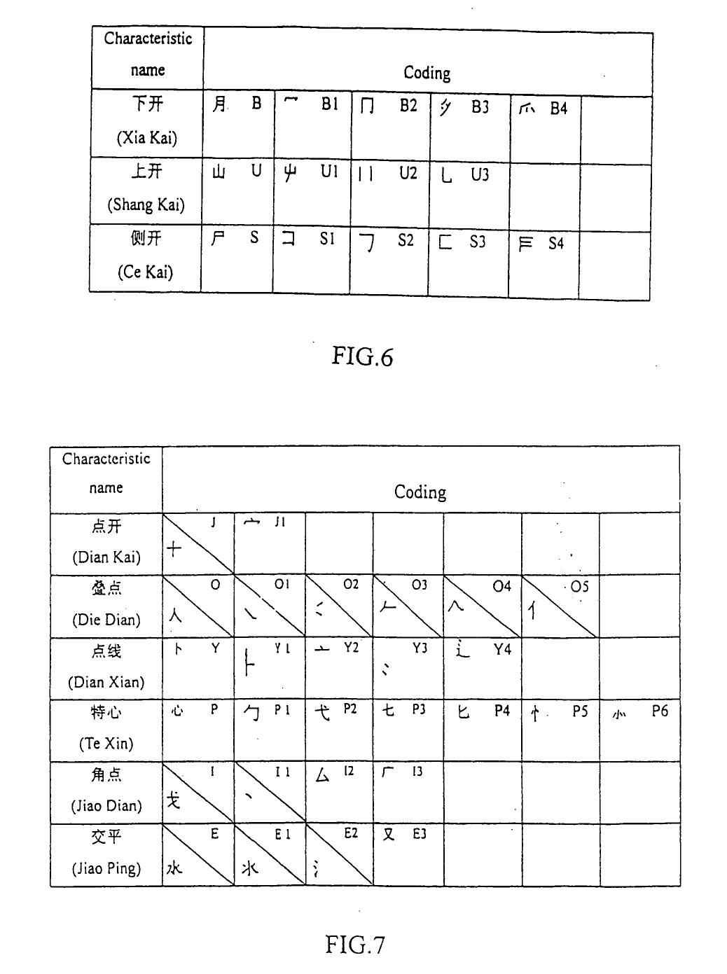

FIG. 6 shows the strike code elements of “square” character pattern, which are 7 in total; FIG. 7 shows the strike code elements of “special” character pattern, which are 16 in total.

FIGS. 1-7, repeated code elements are diagonaized at the stroke code elements, or collected in “special” portion, which are only for reference and uncounted.

Based on long term thorough study on character pattern features of Chinese characters, the invention achieved significant results. The inputting method divided the geometric firs of strokes into seven supergroups of character pattern c eic, each supergroup is divided into several groups, and FIGS. 1-7 represented the character pattern features of seven supergrups of character pattern chaacteristics in dot, line, cross, corner, open, square and special of sorting in the inputting method. The divided character patters, using an example as shown in FIG. 1, the first character pattern of each row represent the character pattern itself is shown by an English alphabet having a serial number of 0, and typically the serial number is unexpressed; the remaining character patter in each row are auxiliaries; similarly, they are represented by said English alphabets having serial numbers 1, 2, 3, 4, 5, 6 respectively. There are 16 “dot” character patterns in FIG. 1, 16 “line” character patterns in FIG. 2, 22 “cross” character patterns in FIG. 3, 9 “corner” character patterns in FIG. 4, 14 “open” character patterns in FIG. 5, 7 “square” character patterns in FIG. 6, 16 “special” character patterns in FIG. 7, and 100 character patterns totaled in above mentioned FIGS. 1-7. As input code elements of Chinese characters, the 100 character patterns are allocated corresponding English alphabet key sites and relevant numeric key sites of the computer input keyboard. Above keyboard may be in conventional English or specially designed. On inputting, besides depressing the relent English alphabet keys, in the meantime, the character pattem code elements of auxiliary characters of relevant numeric keys can be depressed in addition.

Aforesaid 7 supergroups of representative character patterns and auxiliary character patterns of stroke characteristics have already covered all the stroke features, of Chinese characters which are substantive in the invention discriminating with the prior art, utilizing these character pattern input code elements, the input modes can be flexibly adjusted to be in compatible with other inputting methods. Take the left up, left down, right up and right down in the quadrangle for coding points, the inputting method can achieve different coding orders to define different input coding, consequently, it can be used in computer inputting of characters of multiple countries in Asia.

The inputting method can adopt one of the four modes:

(1) Four inputting methods of single code:

select left up code element:

select left down code element:

select right up code element;

select right down code element:

(2) Three inputting methods of double code:

Left up code element+left down code element:

Left up code element+right up code element;

Left up code element+right down code element.

(3) Two inputting methods of triple code;

left up code element+right down code element+left down code element;

left up code element+right down code element+right up code element.

(4) Two inputting methods of quadrupole code:

left up code element+left down code element+right up code element+right down code element;

left up code clement+right up code element+left down code element+right down code element.

Generally speaking, in the above mentioned four inputting methods, the less the input code elements, the higher the repetition rate; on the contrry the more the input code elements, the lower the repetition rate. A flexible application problem is herein. When the strokes of a Chinese character is relatively less, using single code input or double code input is more convenient; for Chinese characters having more strokes, of course, it is more suitable for inputting of triple codes or quadrupole codes. Nomatter whichever of the above inputting method, on input operation, all of them are matching with the computer display, following the input operation order of character, repeated characters comprising Chinese characters ready for input are renewed at all times on the display, once a standby Chinese character appears, then it can be selected on the display. Because the inputting method uses character pattern characteitics in coding, i.e. e the stroke parts of Chinese cheracters for basic coding objects, sdeldng to above mentioned four inputting methods is unnessary, therefore, according to specified 100 input code element, inputting of the beginning and the end code elements of Chinese characters via Keying is also probable.

For instance A characteristic of characr [symbol] (Ji) is [symbol] (Jiao Fang) and a coding of the inputti method is G2R0. A quick leaning code is also GR.

A characteristic of character [symbol] (Che) is [symbol] (Jiao Jiao) and a coding of the inputting method is J0J0. A quick leaning code is JJ.

A characteristic of character [symbol] (Xi) is [symbol] (Xian Dian) and a coding of the inputting method is H1FI. A quick lerning code is HF.

A characteristic of character [symbol] (She) is [symbol] (Xian Fang) and a coding of the inputting method is H1RO. A quick learning code is HR.

A characteristic of character [symbol] (Yan) is [symbol] (Jian Fang) and a coding of the inputting method is YZRO. A quick learning code is YR.

In application, it is preferable that the inputting method shall be compatible with the quick lerning inputting method. Numerals can be omitted on compatible inputting of [symbol] (Cang Ji) or quick learnig method. Therefore the inputting method is called as a happy, interesting, quick leaning inputting method.

In aspects of compatible with [symbol] (Cang Ji) coding, when there are more stokes of the character pattern parts or being difficult in discription, one more stroke c erstic shall be taken between beginning and the end, so as to represent the part by the beginning, the middle and the end keys, to reduce repeated codes and enhance the accuracy.

For example; A characteristic of the right side character [symbol] (Zheng) in a character [symbol] (heng) is [symbol] (Xian Xian), a coding of the inputting method is MOMO, a compatible [symbol] (Cang Ji) coding is MoY1M0, [symbol] (Cang Ji) coding is MYM. The traditional [symbol] (Cong Ji) coding of character [symbol] (Zheng) is HOMYM.

A characteristic of a right side character [< (Mian)] in a character [symbol] (Wan) is [symbol] (Jiao Kai), a coding of the inputting method is N3U3, a compatible [symbol] (Cang Ji) coding is N3A1U3, and the traditional [symbol] (Cang Ji) coding of character [symbol] (Wan) is ANAU.

A characteristic of right side character [symbol] (Ji) in a character [symbol] (Ji) is [symbol] (Jiao Jian), a coding of the inputting method is N1E3, a compatible [symbol] (Cang Ji) coding is N1H1E3. The traditional [symbol] (Cang Ji) coding of the character [symbol] (Ji) is GNHE.

A characteristic of right side character [symbol] (Wan) in a character [symbol] (Wan) is is [symbol] (Jiao Kai), a coding of the inputting method is J1U3, a compatible [symbol] (Cang Ji) coding is J1M0U3. The traditional [symbol] (Cang Ji) coding of the character [symbol] (Ji) is EJMU.

A characteristic of right side character [symbol] (Ke) in a character [symbol] (He) is line square, a coding of the inputting method is M0R0, a compatible [symbol] (Cang Ji) coding is M0N2R0. A traditional [symbol] (Cang Ji) coding of the character [symbol] (He) is OMNR.

A characteristic of right side character [symbol] (Dui) in a character [symbol] (Shuo) is [symbol] (Dian Kai), a coding of the inputting method is C2U3, a compatible [symbol] (Cang Ji) coding is C2R0U3. The traditional [symbol] (Cang Ji) coding of the character [symbol] (He) is YRCRU.

A characteristic of right side character [symbol] (Jiao) in a character [symbol] (Jiao) is [symbol] (Jian Jiao), a coding of the inputting method is Y2K2, a compatible [symbol] (Cang Ji) coding is Y2C2K2. The traditional [symbol] (Cang Ji) coding of the character [symbol] (He) is JJYCK.

If some extremely complicated characters were encountered, special processing shall be performed, e.g. a code x shall be used to represent a compicated item. For example, a coding of a character [symbol] (Qi) is Y2X0, a coding of a character [symbol] (Su) is L2X0, a coding of a character [symbol] (Jiou) is H1X0, acoding of a character [symbol] (Shen) is H1X0H1, and a coding of a character [symbol] (Gui) is N2X0U3.

1. A happy, interesting, quick learning inputting method of Chinese characters in stroke character pattern codes, wherein:
a. 100 input code elements of Chinese characters are divided according to seven supoups of [symbol] (dot), [symbol] (line). [symbol] (cross), [symbol] (corner), [symbol] (open), [symbol] (square), and [symbol] (special) in Chinese characters, the 100 code elements are allocated of English alphabet key sites and auxliary stroke character patn code elements are discriminated by corresponding keys of numeric serial number, and a layout of keyboard is as follows:

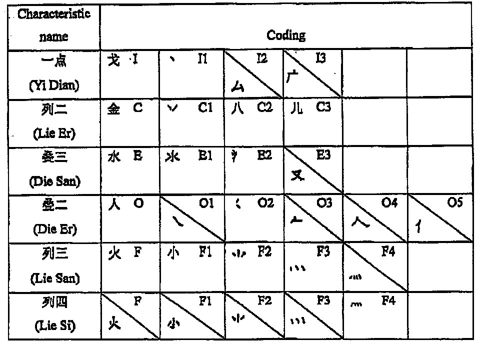

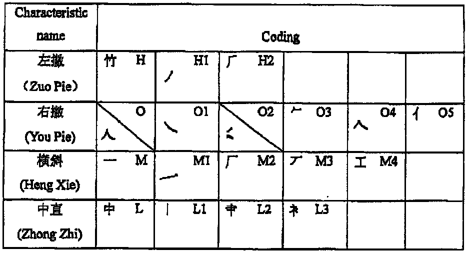

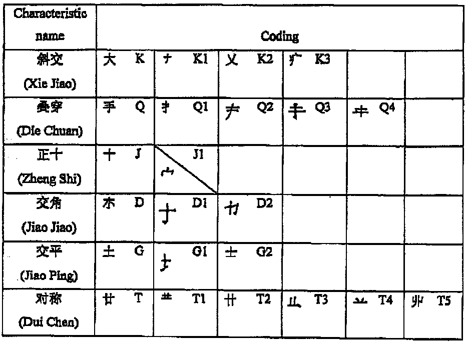

| | |
|---|---|
| Characteristic | |
| name | Coding |
| | | | | | |
|---|---|---|---|---|---|
| [symbol] | [symbol] V | [symbol] V1 | [symbol] V2 | [symbol] V3 | |
| (Zuo Jiao) | | | | | |
| [symbol] | [symbol] N | [symbol] N1 | [symbol] N2 | [symbol] N3 | [symbol] N4 |
| (Yoy Jiao) | | | | | |
| | |
|---|---|
| Characteristic | |
| name | Coding |
| | | | |
|---|---|---|---|
| [symbol] | [symbol] W | [symbol] W1 | [symbol] W2 |
| (Da Kou) | | | |
| [symbol] | [symbol] A | [symbol] A1 | [symbol] A2 |
| (Shuang Kou) | | | |
| [symbol] | [symbol] R | | |
| (Dan Kou) | | | |
| | |
|---|---|
| Characteristic | |
| name | Coding |
| | | | | | |
|---|---|---|---|---|---|
| [symbol] | [symbol] B | [symbol] B1 | [symbol] B2 | [symbol] B3 | [symbol] B4 |
| (Xia Kai) | | | | | |
| [symbol] | [symbol] U | [symbol] U1 | [symbol] U2 | [symbol] U3 | |
| (Shang Kai) | | | | | |
| [symbol] | [symbol] S | [symbol] S1 | [symbol] S2 | [symbol] S3 | [symbol] S4 |
| (Ce Kai) | | | | | |

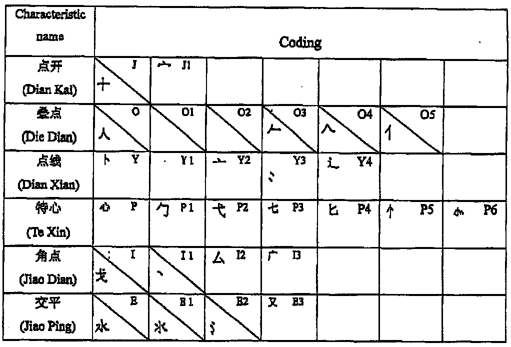

b. On inputting Chinese charactes, the order is in accordance with the rules of quadrangle in the Chinese characters or the beginning and the end of Chinese characters, and keyed in with above corresponding code elements of stroke c er patterns.

2. The inputting method of Chinese chaacters according to claim 1, wherein, on entering single codes, left up code clement, left down code element, right up code element, or right down code element on the quadrange of the Chinese character can be selected.

3. The inputting method of Chinese characters according to claim 1, wherein, on inputting double codes, three methods can be used:
a. left up code element+left down code element;
b. left up code element+right up code element;
C. left up code element+right down code element.

4. The inputting method of Chinese characters according to claim 1, wherein, on inputting tiple codes, two methods can be used,;
a. left up code element+right down code element+left down code element;
b. left up code element+right down code element+right up code element;

5. The inputting method of Chinese characters according to claim 1, wherein, on inputting quadruple codes, two methods can be used;
a. left up code element+left down code element+right up code element+right down code element;
b. left up code element+right up code element+left down code element+right down code element.

6. The inputting method of Chinese characters according to claim 1, wherein, on inputting codes in accordance with the beginning and the end of Chiese characters, an inputting method of the beginning code element+the middle element+the end code element shall be adopted.

7. The inputing method of Chinese characters according to claim 1, wherein, a X key can be used to replace any of the complicated codes besides the afbresaid 100 input codes in entering Chinese characters.
